(19) United States
(12) Patent Application Publication
(10) Pub. No.: US 2023/0403395 A1
(43) Pub. Date: Dec. 14, 2023

(54) DATA COMPRESSION METHOD FOR QUANTITATIVE REMOTE SENSING WITH UNMANNED AERIAL VEHICLE

(71) Applicants: NORTH CHINA INSTITUTE OF AEROSPACE ENGINEERING, Hebei (CN); AEROSPACE INFORMATION RESEARCH INSTITUTE , CHINESE ACADEMY OF SCIENCES, Beijing (CN)

(72) Inventors: Wenhao Zhang, Hebei (CN); Yongtao Jin, Hebei (CN); Guohong Li, Hebei (CN); Xingfa Gu, Beijing (CN); Xiaomin Tian; Xia Zhu, Hebei (CN); Mengxu Zhu, Hebei (CN)

(21) Appl. No.: 18/226,038

(22) Filed: Jul. 25, 2023

(30) Foreign Application Priority Data
Jun. 13, 2022 (CN) 202210673676.1
Apr. 12, 2023 (WO) PCT/CN2023/087731

(51) Int. Cl. H04N 19/124; H04N 19/91; H04N 19/147

(52) U.S. Cl. CPC H04N 19/124; H04N 19/91; H04N 19/147

(57) ABSTRACT

The present disclosure provides a data compression method for quantitative remote sensing with an unmanned aerial vehicle. The method performs preprocessing on a multispectral image acquired by an unmanned aerial vehicle, successively performs a three-dimensional convolution and a two-dimensional convolution on the multispectral image by an encoder to obtain deep feature information, performs quantizing and entropy encoding on the deep feature information, optimally distributes a loss and a code rate of the image through end-to-end joint training to obtain an optimal compressed image, and reconstructs the optimal compressed image by using a decoder. Image reconstruction quality and a compression ratio are improved by performing a plurality of convolutions on a multispectral pattern; quantizing and entropy encoding are performed on the convoluted deep feature information, to remove redundancy in a feature image, so as to improve the image reconstruction quality and the compression ratio.

### CROSS REFERENCE TO RELATED APPLICATION

The present disclosure is a national stage application of International Patent Application No. PCT/CN2023/087731, filed on Apr. 14, 2023, which claims priority to the Chinese Patent Application No. 202210673676.1, filed with the China National Intellectual Property Administration, Jun. 13, 2022, and entitled “DATA COMPRESSION METHOD FOR QUANTITATIVE REMOTE SENSING WITH UNMANNED AERIAL VEHICLE”, which is incorporated herein by reference in its entirety.

### TECHNICAL FIELD

The present disclosure relates to the technical field of a compression method, and particularly, to a data compression method for quantitative remote sensing with an unmanned aerial vehicle.

### BACKGROUND

Currently, an unmanned aerial vehicle-based remote sensing image can be compressed by a conventional image compression method and a deep learning-based image compression method. Conventional image compression methods include three main categories: a prediction-based image compression method, a vector quantization-based image compression method, and a transformation-based image compression method. The prediction-based image compression method predicts a current pixel value through context information of an adjacent element by using a correlation between a neighboring element and a band of an image, thereby realizing image compression. The prediction-based image compression method is commonly known as differential pulse modulation, which minimizes a residual value of an image by selecting a prediction coefficient. The vector quantization-based image compression method is performed by converting some scalars of an image into a vector, to integrate vector space, so as to compress data. This method makes full use of the correlation of the image, and has high coding performance. However, it is difficult to encode the image, and it consumes a lot in computational resources. The transformation-based image compression method is performed by transforming an image from a spatial domain to a transform domain, and compression coding is performed in the transform domain. Common transform methods include principal component analysis, discrete cosine transform, discrete wavelet transform, and Karhunen-Loeve transform.

The prediction-based image compression method, the vector quantization-based image compression method, and the transformation-based image compression method are all used to compress a pixel value of an unmanned aerial vehicle-based remote sensing image, a compression ratio is low, and distortion may occur to different degrees. Even when a high compression ratio is implemented, a computer memory overflows due to a large quantity of data, thereby causing problems such as block effects, blurring, and artifacts in a compressed image, which seriously affect quantitative remote sensing with the unmanned aerial vehicle-based remote sensing image.

### SUMMARY

In view of the foregoing drawbacks or deficiencies in the conventional technology, the present disclosure provides a data compression method for quantitative remote sensing with an unmanned aerial vehicle.

To achieve the foregoing objective, the present disclosure provides the following solutions:

A data compression method for quantitative remote sensing with an unmanned aerial vehicle includes:
S100: performing preprocessing on a multispectral image acquired by an unmanned aerial vehicle;
S200: successively performing, by an encoder, a three-dimensional convolution and a two-dimensional convolution on the multispectral image to obtain deep feature information;
S300: performing quantizing and entropy encoding on the deep feature information;
S400: optimally distributing a loss and a code rate of an image through end-to-end joint training to obtain an optimal compressed image; and
S500: reconstructing, by a decoder, the optimal compressed image.

According to the technical solution provided in an embodiment of the present disclosure, the performing preprocessing on a multispectral image acquired by an unmanned aerial vehicle includes:
S100.1: acquiring a multi spectral image of a target area;
S100.2: extracting, by a scale invariant feature transform (SIFT) operator, feature points in the multispectral image, and splicing the feature points into a multispectral remote sensing image according to feature point information;
S100.3: radiometrically calibrating the multispectral remote sensing image to convert a digital number (DN) value of the multispectral remote sensing image to a surface reflectance; and
S100.4: cropping the multispectral remote sensing image to obtain a multispectral image of 256×256 pixels.

According to the technical solution provided in the embodiment of the present disclosure, the encoder includes an auto-encoder and a hyperparameter encoder. The auto-encoder is configured to three-dimensionally convolve an N×256×256 multispectral image into a 320×16×16 feature image.

The hyperparameter encoder is configured to two-dimensionally convolve the 320×16×16 feature image into a 320×4×4 feature image.

According to the technical solution provided in the embodiment of the present disclosure, the auto-encoder includes a three-dimensional convolutional layer and a generalized divisive normalization (GDN) activation function; the three-dimensional convolutional layer employs a three-dimensional 5×5 convolution kernel with a stride of 2; and the GDN activation function is configured to increase a non-linear relationship between three-dimensional convolutional layers.

According to the technical solution provided in the embodiment of the present disclosure, the hyperparameter encoder includes a two-dimensional convolutional layer and a LeakyReLU activation function; the two-dimensional convolutional layer employs a two-dimensional 5×5 convolution kernel with a stride of 2; and the LeakyReLU activation function is configured to increase a non-linear relationship between two-dimensional convolutional layers.

According to the technical solution provided in the embodiment of the present disclosure, the decoder includes an auto-decoder and a hyperparameter decoder, the auto-decoder and the auto-encoder are symmetrical to each other, and the hyperparameter decoder and the hyperparameter encoder are symmetrical to each other.

According to the technical solution provided in the embodiment of the present disclosure, the performing quantizing and entropy encoding on the deep feature information includes the following steps:
S300.1: converting floating-point data of the deep feature information into an integer; and
S300.2: performing an entropy estimation on the entropy encoding by using a double Gaussian model.

According to a specific embodiment provided in the present disclosure, the present disclosure provides the following technical effects:

The present disclosure provides a data compression method for quantitative remote sensing with an unmanned aerial vehicle. Firstly, an image acquired by the unmanned aerial vehicle is preprocessed to obtain a multi-spectrum image which is available, the multi-spectrum image is subjected to a three-dimensional convolution and a two-dimensional convolution by an encoder to obtain deep feature information to implement compression, quantizing and entropy encoding are performed on the deep feature information to further remove redundancy in a feature image, the loss and the code rate of the image are adjusted to optimal distribution through end-to-end joint training to obtain an optimal compressed image, and finally the optimal compressed image is reconstructed by using a decoder for subsequent use.

Image reconstruction quality and a compression ratio are improved by performing a plurality of convolutions on a multispectral pattern, including the three-dimensional convolution and the two-dimensional convolution; quantizing and entropy encoding are performed on the convoluted deep feature information, to further remove redundancy in a feature image, so as to further improve the image reconstruction quality and the compression ratio; and the loss and the code rate of the image are adjusted to an optimal ratio, so that a high compression ratio can be achieved while improving compression quality and preventing the occurrence of problems such as block effects, blurring, and artifacts.

### BRIEF DESCRIPTION OF THE DRAWINGS

To describe technical solutions in embodiments of the present disclosure or in the conventional technology more clearly, the following briefly describes accompanying drawings required for describing embodiments. Apparently, the accompanying drawings in the following description merely show some embodiments of the present disclosure, and a person of ordinary skill in the art may still derive other drawings from these accompanying drawings without creative efforts.

FIG. 1 is a schematic flow diagram of a data compression method for quantitative remote sensing with an unmanned aerial vehicle according to an embodiment of the present disclosure;

FIG. 2 is a data compression model diagram of a data compression method for quantitative remote sensing with an unmanned aerial vehicle according to an embodiment of the present disclosure;

FIG. 3 is a data compression model diagram of a data compression method for quantitative remote sensing with an unmanned aerial vehicle according to an embodiment of the present disclosure; and

FIGS. 4A-B are water body extraction result diagrams of a data compression method for quantitative remote sensing with an unmanned aerial vehicle according to an embodiment of the present disclosure; FIG. 4A is a slender water body extraction result diagram of a compressed remote sensing image of an unmanned aerial vehicle; and FIG. 4B is a block water body extraction result diagram of a compressed remote sensing image of an unmanned aerial vehicle.

### DETAILED DESCRIPTION OF THE EMBODIMENTS

The following clearly and fully describes technical solutions in embodiments of the present disclosure with reference to accompanying drawings in the embodiments of the present disclosure. Apparently, the described embodiments are merely a part rather than all of the embodiments of the present disclosure. All other embodiments obtained by a person of ordinary skill in the art based on the embodiments of the present disclosure without creative efforts shall fall within the protection scope of the present disclosure.

To make the foregoing objectives, features, and advantages of the present disclosure clearer and more comprehensible, the present disclosure will be further described in detail below with reference to the accompanying drawings and specific implementations.

### Embodiment 1

Currently, an unmanned aerial vehicle-based remote sensing image can be compressed by a conventional image compression method and a deep learning-based image compression algorithm based on. Conventional image compression methods include three main categories: a prediction-based image compression method, a vector quantization-based image compression method, and a transformation-based image compression method. These methods are all used to compress a pixel value of an unmanned aerial vehicle-based remote sensing image, a compression ratio is low, and distortion may occur to different degrees. Even when a high compression ratio is implemented, a computer memory overflows due to a large quantity of data, thereby causing problems such as block effects, blurring, and artifacts in a compressed image, which seriously affect quantitative remote sensing with the unmanned aerial vehicle-based remote sensing image.

Although an image compression method based on deep learning improves an image compression ratio and reconstruction quality to some extent, the image compression method based on deep learning does not consider a quantitative remote sensing use scenario of the unmanned aerial vehicle, a data source is relatively simple, most of which are false color data of a red, green, blue (RGB) type, and there is no a compression algorithm designed for the quantitative remote sensing with the unmanned aerial vehicle-based remote sensing image.

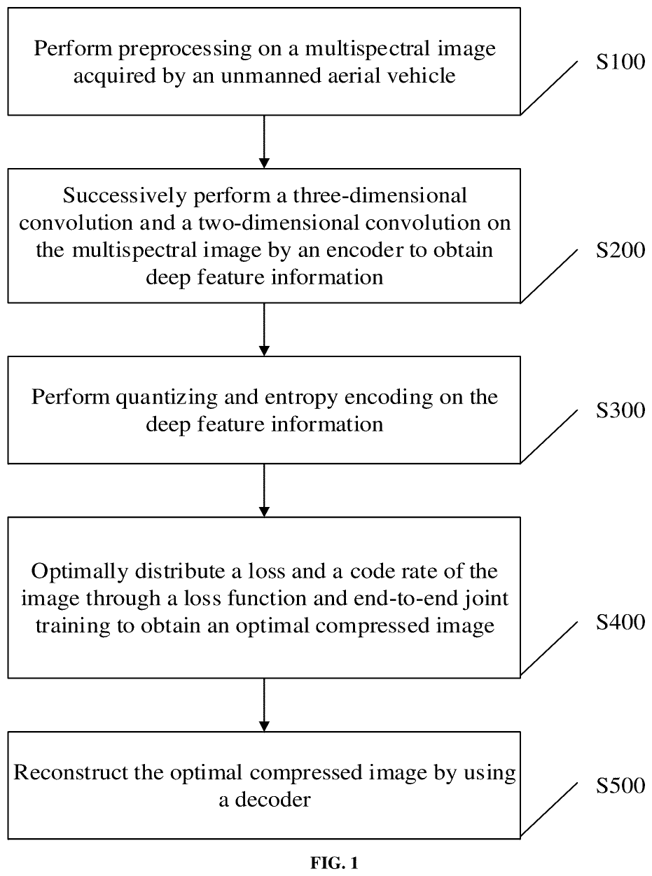

To solve the foregoing problem, the present disclosure provides a data compression method for quantitative remote sensing with an unmanned aerial vehicle, as shown in FIG. 1, including the following steps.
S100: Perform preprocessing on a multispectral image acquired by an unmanned aerial vehicle, which specifically includes the following steps:
S100.1 Acquire a multispectral image of a target area, where a multispectral image of a target area is acquired by using an unmanned aerial vehicle mounted a multispectral camera.
S100.2 Extract feature point information in the multispectral image by using a scale invariant feature transform (SIFT) operator, and splice the feature point information into a multispectral remote sensing image according to feature point information, thereby implementing registration of the unmanned aerial vehicle-based remote sensing image.
S100.3 Radiometrically calibrate the multispectral remote sensing image to convert a digital number (DN) value of the multispectral remote sensing image to a surface reflectance. An invariant target method is used to measure reflectance data of a fixed target by using an analytical spectral device (ASD) spectrometer, and radiometrically calibrate the multispectral remote sensing image according to a relationship between reflectances of an invariant target in different time phases and the unmanned aerial vehicle-based remote sensing image, to convert a DN value of an unmanned aerial vehicle image into the surface reflectance. The method can convert multispectral data acquired by different sensors and data with different quantization criteria into a same measurement standard, and the process eliminates instrument errors caused by different sensors in a compression process.
S100.4 Crop the multispectral remote sensing image after being radiometrically calibrated to obtain a multispectral image of 256×256 pixels.

Further, a data compression model for quantitative remote sensing with an unmanned aerial vehicle is designed, where the compression model includes the following S200-S400.

S200: Successively perform a three-dimensional convolution and a two-dimensional convolution on the multispectral image by an encoder to obtain deep feature information.

Further, the encoder includes an auto-encoder and a hyperparameter encoder, the auto-encoder is configured to three-dimensionally convolve an N×256×256 multispectral image into a 320×16×16 feature image, and the hyperparameter encoder is configured to two-dimensionally convolve the 320×16×16 feature image into a 320×4×4 feature image.

The auto-encoder includes a three-dimensional convolutional layer and a generalized divisive normalization (GDN) activation function, the three-dimensional convolutional layer employs a three-dimensional 5×5 convolution kernel with a stride of 2, and the GDN activation function is configured to increase a non-linear relationship between three-dimensional convolutional layers. The GDN activation function is expressed as Formula (1):

$$y = g ( x ; θ ) s . t . {y}_{i} = \frac{{x}_{i}}{{( {β}^{i} + {Σγ}_{ij} \vert {z}_{j} \vert {a}^{ij} )}^{ε i}} . \qquad ( 1 )$$

θ={α, β, γ, ε} is a corresponding parameter of the transformation.

An operating principle is that the preprocessed unmanned aerial vehicle-based remote sensing image is cropped to an image of an n×256×256 size, and spectral information between bands of a multispectral image is first extracted by using a three-dimensional convolutional structure. A convolution kernel size of the three-dimensional convolutional layer is n×1×1, and spectral features of the multispectral image are extracted by using a small convolution kernel. An input image is convoluted by using a convolutional layer with a convolution kernel which has a size of 5, a stride of 2, and a zero fill of 2, to obtain 192 feature images with a size of 128×128. Then, two convolutional layers are connected by using the GDN activation function, which is used to increase a non-linear relationship between layers of a convolutional neural network. The convolution kernel size of the three-dimensional convolutional layer is n×1×1, and the spectral features of the multispectral image are extracted by using a small convolution kernel, so that a problem in which a computer memory overflows due to excessive data amount is avoided.

The hyperparameter encoder includes a two-dimensional convolutional layer and a LeakyReLU activation function, the two-dimensional convolutional layer employs a two-dimensional 5×5 convolution kernel with a stride of 2, and the LeakyReLU activation function is configured to increase a non-linear relationship between two-dimensional convolutional layers.

The LeakyReLU activation function is expressed as Formula (2):

$${y}_{i} = \{ \begin{matrix}{x}_{i} & if {x}_{i} \geq 0 \\ \frac{{x}_{i}}{{a}_{i}} & if {X}_{i} ≺ 0\end{matrix} . \qquad ( 2 )$$

ai is a fixed parameter in an interval (1, +∞), xi represents a feature diagram input at the ith layer, and yi represents a feature diagram output at the ith layer.

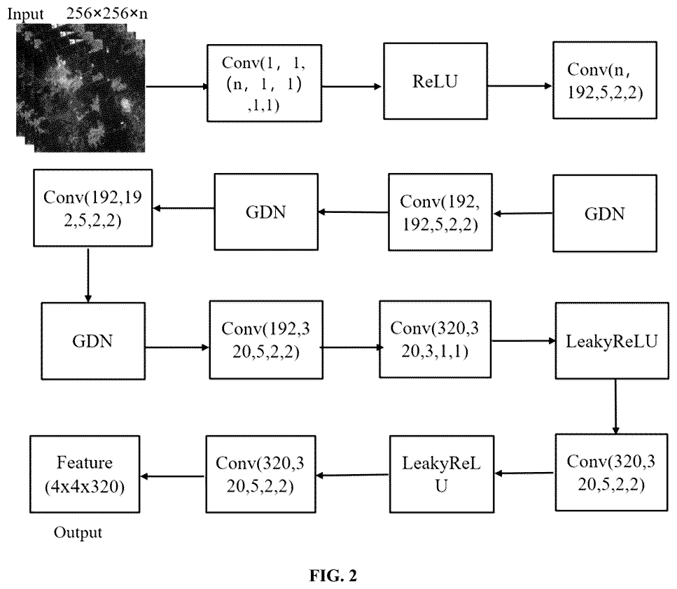

An operating principle is shown as follows. As shown in FIG. 2, first four convolutional layers and the GDN activation function for connecting convolutional layers constitute a basic auto-encoder, and the auto-encoder can further compress image data. A hyperparameter encoder is designed and placed after the auto-encoder. The hyperparameter encoder takes the 320×16×16 feature image output by the auto-encoder as an input image, and processes the feature image by using a convolutional layer with a convolution kernel which has a size of 3, a stride of 1, and a zero fill of 1, to obtain a new 320×16×16 feature image. Then, the new feature image is downsampled by using a convolutional layer with a convolution kernel which has a size of 5, a stride of 2, and a zero fill of 2. The LeakyReLU activation function is used to increase a non-linear relationship between convolutional layers of the network, and finally a set of 320×4×4 feature vectors is obtained. The hyperparameter encoder further reduces a data dimension and extracts deep feature information of the image. In FIG. 2, Input denotes an input, Output denotes an output, Feature denotes a feature, Cony denotes a convolution, ReLU denotes a ReLU activation function, GDN denotes a GDN activation function, and LeakyReLU denotes a LeakyReLU activation function.

S300: Perform quantizing and entropy encoding on the deep feature information, which specifically includes the following steps:
S300.1 Convert floating-point data of the deep feature information into an integer data.

Image feature data extracted by the auto-encoder is floating-point data. When the floating-point data is stored, a large amount of storage space is occupied, and quantization processing needs to be performed on the feature data. The floating-point data is quantized into an integer through the quantization processing, and a part of the information is lost in the quantization process, which has an effect on the quality of a reconstructed image. A principle of a quantization structure is to convert the floating-point data of the feature image into integer data, and the formula thereof is shown in Formula (3):

ŷᵢ=qᵢ=round(yᵢ) (3).

yᵢ is a characteristic diagram output by the auto-encoder, and ŷᵢ is a quantization result.

After a feature of an image is extracted and quantized by the auto-encoder, there is still redundancy not being fully removed. Therefore, it is necessary to remove the redundancy in the quantized feature image by relying on an efficient entropy encoding process, so that encoding performance is further improved. The entropy encoding in this part is arithmetic coding, so that the redundancy in the feature image can be removed without loss.

S300.2 Perform an entropy estimation on the entropy encoding by using a double Gaussian model.

In an end-to-end image compression system, a result of entropy encoding requires an accurate code rate estimation, and a prior probability model of a potential feature is used in an entropy encoding process to perform a symbol probability estimation. Information 2 is introduced to estimate distribution of 9. A Gaussian mixture model has a more powerful data distribution approximation ability. Any continuous probability distribution of data can be approximated by increasing a quantity of Gaussian models in the Gaussian mixture model. The entropy estimation is performed by using the double Gaussian model in the present disclosure, and a distribution function of the double Gaussian model 9 is shown in Formula (4):

p_{ŷ|\hat{z}}(ŷ|\hat{z})˜Σᵢ₌₁²wᵢN(uᵢ,σᵢ) (4).

wᵢ represents weights of different Gaussian models, N(uᵢ, σᵢ) represents a distribution parameter of a Gaussian model, and p_{ŷ|\hat{z}}(ŷ|\hat{z}) represents an entropy encoding result.

In this step, entropy encoding processing is first performed on the integer data to obtain an entropy encoding result, and then the entropy estimation is performed on the entropy encoding result by using the double Gaussian model to obtain a loss value and a code rate of the image.

S400: Optimally distribute a loss and a code rate of the image through a loss function and end-to-end joint training to obtain an optimal compressed image.

For end-to-end encoding, rate-distortion optimization is a joint optimization of image distortion and a compression code rate, and optimization results of a code rate estimation and the image distortion directly affect an optimization effect of an entire end-to-end convolutional neural network image compression algorithm. In order to better optimize compression performance of an image, a loss function employed for the rate-distortion optimization of the end-to-end convolutional neural network image compression algorithm is shown in Formula (5):

L=R+λD=λd(x,\hat{x})+H(ŷ)+H(\hat{z}) (5).

D represents distortion, and mean square errors of an original image and a reconstructed image represent a degree of distortion of the image. R represents a code rate. λ represents a balance coefficient of the distortion and the code rate. d(x, \hat{x}) represents the degree of distortion. H(ŷ) and H(\hat{z}) represent code rates of ŷ and \hat{z}. The loss function includes a code rate of the end-to-end convolutional neural network image compression algorithm and a loss value between the original image and the reconstructed image. A code rate estimation of the end-to-end convolutional neural network image compression algorithm is shown in Formula (6) and Formula (7).

H(ŷ)=E[−log₂(p_{ŷ|\hat{z}}(ŷ|\hat{z}))] (6).

H(\hat{z})=E[−log₂(p_{\hat{z}}(\hat{z}))] (7).

Further, p_{ŷ|\hat{z}}(ŷ|\hat{z}) and p_{\hat{z}}(\hat{z}) represent distribution of ŷ and \hat{z}. In a training process of the end-to-end convolutional neural network image compression algorithm, allocation of an image loss and the code rate is continuously adjusted, so that the image loss and the code rate are balanced, and image reconstruction quality and image compression efficiency are ensured.

S500: Reconstruct the optimal compressed image by using a decoder.

An auto-decoder and a hyperparameter decoder are used in reconstructing an image, the auto-decoder has a completely symmetrical structure with the auto-encoder, and the auto-decoder includes a deconvolution layer, an IGDN activation function, and a LeakyReLU activation function. A formula of the IGDN activation function is shown in (8).

zᵢ⁽ⁿ⁺¹⁾=(βⁱ+Σγᵢⱼ|zⱼ|ₐᵢⱼ)^{εi}yᵢ (8).

θ={α, β, γ, ε} is a corresponding parameter of the transformation.

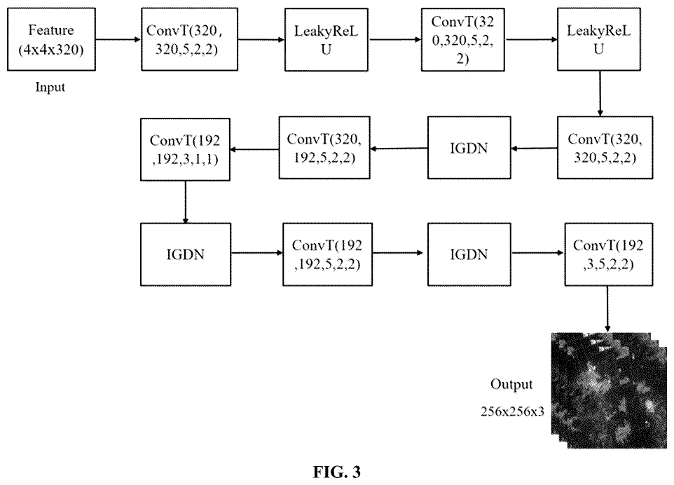

An operating principle is shown as follows: As shown in FIG. 3, a feature vector of a size of 320×4×4 obtained by the auto-encoder is input into the auto-decoder, and a deconvolution operation is performed on the input image with a convolutional layer with a convolution kernel which has a size of 5, a stride of 2, and a zero fill of 2, to obtain 320 feature maps of a size of 8×8. The IGDN activation function and the LeakyReLU activation function are connected to two convolutional layers for increasing a non-linear relationship between layers of a compression network. First three convolutional layers and the LeakyReLU activation function for connecting convolutional layers constitute a hyperparameter decoder, and the decoder follows the hyperparameter decoder. The decoder has a structure corresponding to the encoder to restore the feature image to a feature vector of a size of n×256×256. The feature vector of n×256×256 is restored to a reconstructed image with coordinate information by using a GDAL library (Geospatial Data Abstraction Library). In FIG. 3, Feature denotes a feature, Input denotes an input, Output denotes an output, ConvT denotes a deconvolution, LeakyReLU denotes a LeakyReLU activation function, and IGDN denotes an IGDN activation function.

The reconstructed image with the coordinate information of a size of 256×256 is spliced and fused, and several images of a size of 256×256 are spliced into an entire image.

### Embodiment 2

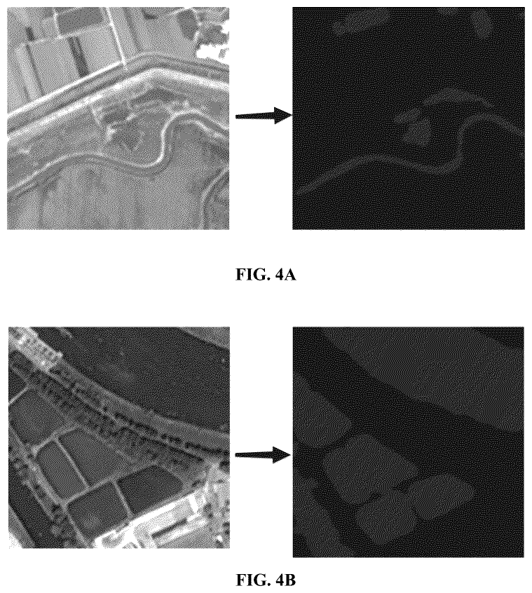

As shown in FIGS. 4A-B, quantitative remote sensing with an unmanned aerial vehicle-based remote sensing image uses identification of different types of land objects, such as a leaf area index NDVI and a water body index NDWI.

The leaf area index NDVI is one of the important parameters reflecting crop growth and nutritional information. The calculation principle is a difference between a reflectance value of a near infrared band and a reflectance value of a red-light band divided by a sum of the reflectance value of a near infrared band and the reflectance value of a red-light band, and the calculation is shown in Formula (9).

$$NDVI = \frac{NIR - R}{NIR + R} . \qquad ( 9 )$$

NIR is the reflectance value of the near infrared band, and R is the reflectance value of the red-light band.

The water body index NDWI is one of the important parameters reflecting water body information. The calculation principle is a difference between a reflectance value of a green band and a reflectance value of a near infrared band divided by a sum of the reflectance value of a green band and the reflectance value of a near infrared band, and the calculation is shown in Formula (10).

$$NDVI = \frac{G - NIR}{G + NIR} . \qquad ( 10 )$$

NIR is the reflectance value of the near infrared band, and G is the reflectance value of the green band.

The unmanned aerial vehicle-based remote sensing image is applied for quantitative remote sensing by calculating the leaf area index NDVI and the water body index NDWI of the unmanned aerial vehicle-based remote sensing image, to implement identification and classification of different types of land objects.

Each embodiment in the present disclosure is described in a progressive manner, each embodiment focuses on the difference from other embodiments, and the same and similar parts among the embodiments may refer to each other.

Specific examples are used herein to explain the principles and implementations of the present disclosure. The foregoing description of the embodiments is merely intended to help understand the method of the present disclosure and core ideas thereof. Besides, various modifications may be made by those of ordinary skill in the art to specific implementations and the application scope in accordance with the ideas of the present disclosure. In conclusion, the content of the present disclosure shall not be construed as limitations to the present disclosure.

What is claimed is:

1. A data compression method for quantitative remote sensing with an unmanned aerial vehicle, comprising:
S100: performing preprocessing on a multispectral image acquired by an unmanned aerial vehicle;
S200: successively performing, by an encoder, a three-dimensional convolution and a two-dimensional convolution on the multispectral image to obtain deep feature information;
S300: performing quantizing and entropy encoding on the deep feature information;
S400: optimally distributing a loss and a code rate of the image through end-to-end joint training to obtain an optimal compressed image; and
S500: reconstructing, by a decoder, the optimal compressed image.

2. The data compression method for quantitative remote sensing with an unmanned aerial vehicle according to claim 1, wherein the preprocessing a multispectral image acquired by an unmanned aerial vehicle comprises:
S100.1: acquiring a multispectral image of a target area;
S100.2: extracting, by a scale invariant feature transform (SIFT) operator, feature points in the multispectral image, and splicing the feature points into a multispectral remote sensing image according to feature point information;
S100.3: radiometrically calibrating the multispectral remote sensing image to convert a digital number (DN) value of the multispectral remote sensing image to a surface reflectance; and
S100.4: cropping the multispectral remote sensing image to obtain a multispectral image of 256×256 pixels.

3. The data compression method for quantitative remote sensing with an unmanned aerial vehicle according to claim 1, wherein the encoder comprises an auto-encoder and a hyperparameter encoder; the auto-encoder is configured to three-dimensionally convolve an N×256×256 multispectral image into a 320×16×16 feature image; and the hyperparameter encoder is configured to two-dimensionally convolve the 320×16×16 feature image into a 320×4×4 feature image.

4. The data compression method for quantitative remote sensing with an unmanned aerial vehicle according to claim 3, wherein the auto-encoder comprises a three-dimensional convolutional layer and a generalized divisive normalization (GDN) activation function; the three-dimensional convolutional layer employs a three-dimensional 5×5 convolution kernel with a stride of 2; and the GDN activation function is configured to increase a non-linear relationship between three-dimensional convolutional layers.

5. The data compression method for quantitative remote sensing with an unmanned aerial vehicle according to claim 4, wherein the hyperparameter encoder comprises a two-dimensional convolutional layer and a LeakyReLU activation function; the two-dimensional convolutional layer employs a two-dimensional 5×5 convolution kernel with a stride of 2; and the LeakyReLU activation function is configured to increase a non-linear relationship between two-dimensional convolutional layers.

6. The data compression method for quantitative remote sensing with an unmanned aerial vehicle according to claim 5, wherein the decoder comprises an auto-decoder and a hyperparameter decoder, the auto-decoder and the auto-encoder are symmetrical to each other, and the hyperparameter decoder and the hyperparameter encoder are symmetrical to each other.

7. The data compression method for quantitative remote sensing with an unmanned aerial vehicle according to claim 1, wherein the quantizing and entropy encoding the deep feature information comprises the following steps:
S300.1: converting floating-point data of the deep feature information into an integer; and
S300.2: performing an entropy estimation on the entropy encoding by using a double Gaussian model.
